(19) United States
(12) Patent Application Publication
(10) Pub. No.: US 2026/0147300 A1
(43) Pub. Date: May 28, 2026

(54) IMAGING DIAGNOSTIC APPARATUS AND IMAGING DIAGNOSTIC SYSTEM

(71) Applicant: CANON KABUSHIKI KAISHA, Tokyo (JP)

(72) Inventor: RIKO MIURA, Tokyo (JP)

(21) Appl. No.: 19/395,467

(22) Filed: Nov. 20, 2025

(30) Foreign Application Priority Data
Nov. 26, 2024 (JP) 2024-205844

(51) Int. Cl. G03G 15/00

(52) U.S. Cl. CPC G03G 15/5062; G03G 15/553

(57) ABSTRACT

An imaging diagnostic apparatus connected to a printer includes an image reading unit configured to read a printed product formed by the printer to generate a read image, a detection unit configured to detect whether an image defect exists by comparing the read image with a reference image, and a notification unit configured to notify a user of information, wherein, when the image defect is due to a time-dependent change in the service life of a predetermined component, the notification unit issues a notification of a prediction result of a failure timing of the predetermined component.

### BACKGROUND

### Field of the Technology

The present invention relates to an imaging diagnostic apparatus and an imaging diagnostic system.

### Description of the Related Art

Some image defects involve deterioration of image quality as the number of prints increases. Based on this characteristic, “a minor image defect with image quality acceptable to the user” (hereinafter referred to as a precursor) is detected, and the timing at which the image quality becomes unacceptable to the user (hereinafter referred to as an image defect) can be predicted. As a result, countermeasures such as automatic recovery can be performed on a minor image defect with image quality acceptable to the user, thereby reducing the occurrence of image defects.

In Japanese Patent Application Laid-Open No. 2015-34807, image defects detected a predetermined number of times are determined to be precursors.

### SUMMARY

Embodiments disclosed herein include a technique for predicting the failure timing of a component (whose service life is nearing its end), with respect to precursors that have been detected a plurality of times and determined to be time-dependent rather than sudden. According to embodiments of the present disclosure, there is provided an imaging diagnostic apparatus connected to a printer. The imaging diagnostic apparatus includes an image reading unit configured to read a printed product formed by the printer to generate a read image, a detection unit configured to detect whether an image defect exists by comparing the read image with a reference image, and a notification unit configured to notify a user of information, wherein, when the image defect is due to a time-dependent change in the service life of a predetermined component, the notification unit issues a notification of a prediction result of a failure timing of the predetermined component.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a network configuration including a printing system.

FIG. 2 is a cross-sectional view of an image forming apparatus, illustrating an example of a hardware configuration thereof.

FIG. 3 is a block diagram illustrating the internal configuration of the image forming apparatus, an external controller, and a client PC.

FIG. 4 is a flowchart illustrating the procedure of a precursor diagnosis process.

FIG. 5 is a diagram illustrating an example of image defect levels.

FIG. 6 is a diagram illustrating settings of diagnosable areas of feature-extractable items with respect to RIP data.

FIG. 7 is a diagram illustrating an example of feature-extractable items.

FIG. 8 is a flowchart illustrating the procedure of an image precursor diagnosis process.

FIG. 9 is a flowchart illustrating the procedure of a process of determining a time-dependent change in the service life of a component based on a causal component.

FIG. 10 is a diagram illustrating the transition of the size and contrast of a precursor.

FIG. 11 is a diagram illustrating an example of a failure-timing prediction table.

FIG. 12 is a schematic diagram illustrating diagnosis-result notification settings screens.

FIG. 13 is a schematic diagram illustrating examples of a pop-up display of the diagnosis result.

FIG. 14 is a schematic diagram illustrating an example of a graph display of the diagnosis result.

FIG. 15 is a diagram illustrating an example of changes in NG timing when the NG level is changed.

FIG. 16 is a diagram illustrating an example in which the NG timing changes as printing progresses.

FIG. 17 is a schematic diagram illustrating NG-timing change-notification settings and a notification of change details.

FIG. 18 is a diagram illustrating an example in which the change rate of the service life of the component varies depending on printing conditions.

FIG. 19 is a flowchart illustrating the procedure of determining a time-dependent change in the service life of the component based on the progression of the service life of a component.

FIG. 20 is a diagram illustrating examples of changes in the service life of a component using service life curves of the component.

FIG. 21 is a flowchart illustrating the procedure of determining a time-dependent change in the service life of a component based on a causal component and a calculated component service life curve.

FIG. 22 is a diagram illustrating an example of cycle information for each component and information on a time-dependent change in the service life of a component.

### DESCRIPTION OF THE EMBODIMENTS

Embodiments of the present disclosure will be described in detail hereinbelow with reference to the accompanying drawings. It is to be understood that the following embodiments are not intended to limit the present disclosure according to the appended claims and that not all combinations of the features described in the embodiments are absolutely necessary for the present disclosure. In the present embodiments, an image forming apparatus is described as an example of an information processing apparatus; however, the present disclosure is not limited thereto.

### First Embodiment

### Configuration of Overall System

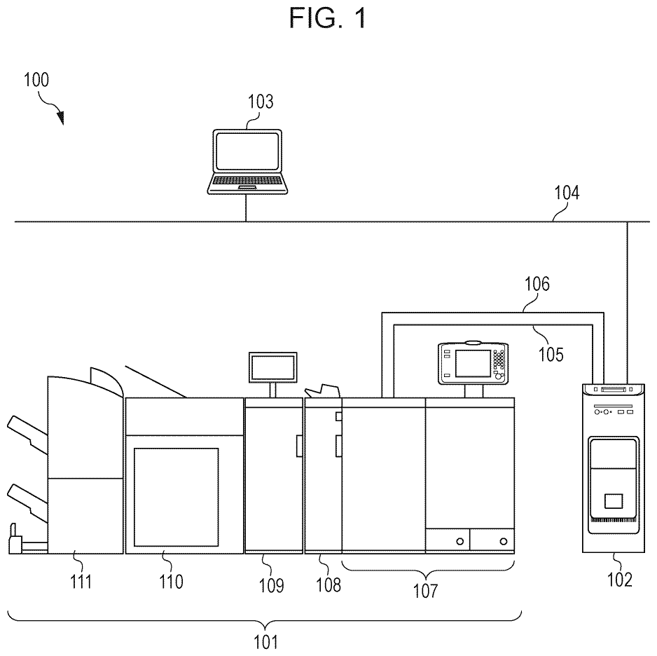

A first embodiment of the present disclosure will be described hereinbelow. Referring to FIG. 1, an example of a network configuration including a printing system (an imaging diagnostic system) according to the present embodiment will be described. As illustrated in FIG. 1, a printing system 100 includes an image forming apparatus 101 and an external controller 102. The image forming apparatus 101 and the external controller 102 are communicably connected via an internal local area network (LAN) 105 and a video cable 106. The external controller 102 is communicably connected to a client personal computer (PC) 103 via an external LAN 104. Although the present embodiment is described using an example in which the image forming apparatus 101 and the external controller 102 are independently provided, this is not intended to limit the present disclosure. For example, the external controller 102 may be integrated with the image forming apparatus 101. In this case, the image forming apparatus 101 and the client PC 103 are communicably connected.

The client PC 103 can provide print instructions to the external controller 102 via the external LAN 104. A printer driver is installed in the client PC 103, the printer driver being configured to convert image data to be printed into a page description language (PDL) that can be processed by the external controller 102. A user desiring to print can issue print instructions, by operating the client PC 103, from various applications installed in the client PC 103 via the printer driver. The printer driver transmits PDL data, which is print data, to the external controller 102 in response to the print instructions from the user. The PDL data includes print data specified by the user, data generated in the client PC 103, and selected data. Upon receiving PDL data from the client PC 103, the external controller 102 analyzes and interprets the received PDL data. The print instructions are issued by rasterizing the PDL data based on the interpretation result to generate a bitmap image (print image data) having a resolution corresponding to the image forming apparatus 101 and by submitting a print job to the image forming apparatus 101.

Next, the image forming apparatus 101 will be described. The image forming apparatus 101 is configured such that multiple devices having different functions are connected so as to perform complex print processing such as book binding.

The image forming apparatus 101 includes a printing unit 107 (image forming unit), an inserter 108, a precursor diagnosis unit 109, a stacker 110, and a finisher 111. The individual modules will be described hereinbelow.

The printing unit 107 prints images according to the details of the print job and discharges printed recording media (paper or sheets). The recording media discharged from the printing unit 107 are conveyed in the interior of each device in order of the inserter 108, the precursor diagnosis unit 109, the stacker 110, and the finisher 111. The printed recording medium is referred to as a printed product. In the present embodiment, the image forming apparatus 101 of the printing system 100 is an example of image forming apparatuses. However, the printing unit 107 included in the image forming apparatus 101 is sometimes referred to as an image forming apparatus. The printing unit 107 forms (prints) images using toner (coloring materials), which are printing media, to recording media fed and conveyed from a feeding device located at the lower part of the printing unit 107.

The inserter 108 is a device that inserts, for example, partitioning recording media, into a series of recording media conveyed from the printing unit 107 at desired positions. The precursor diagnosis unit 109 detects, in the image forming apparatus 101, “a minor image defect with image quality acceptable to the user” (hereinafter referred to as a precursor candidate), based on printed recording media having images formed thereon by the printing unit 107 and conveyed through the conveying path. The precursor diagnosis unit 109 is a device that, among the detected defects, identifies a causal component of a precursor of an image defect due to a time-dependent change in the service life of a component, the precursor being one that develops into “an image defect having an image quality level unacceptable to the user” (hereinafter referred to as an image defect), and predicts the timing at which an image defect occurs. Specifically, the precursor diagnosis unit 109 reads images printed on the printed recording media conveyed and performs a diagnosis from the read images.

The precursor diagnosis includes detecting a precursor candidate from the difference between the read signal values in the read image, determining whether there is a time-dependent change in the service life of the component of the detected precursor candidate, and predicting an image defect according to the result of the determination. A detailed process of the precursor diagnosis unit 109 will be described later. The application of the precursor diagnosis unit 109 is not limited to the above example. It is also possible to provide an inspection system for inspecting printed recording media for a print abnormality, and a diagnosis system for diagnosing an abnormality in the image forming apparatus 101 based on an image defect. The stacker 110 is a device in which a large number of printed recording media can be stacked. The finisher 111 is a device configured to perform finishing processes such as stapling, punching, and saddle stitch binding on conveyed printed recording media. Recording media processed by the finisher 111 are discharged to a predetermined paper discharge tray.

In the configuration example of FIG. 1, the external controller 102 is connected to the image forming apparatus 101; however, the present embodiment may also be applied to a different configuration. For example, the image forming apparatus 101 may be connected to the external LAN 104, and print data may be transmitted from the client PC 103 to the image forming apparatus 101 not via the external controller 102. In this case, the data analysis and rasterization of the print data are executed by the image forming apparatus 101.

### Hardware Configuration of Image Forming Apparatus 101

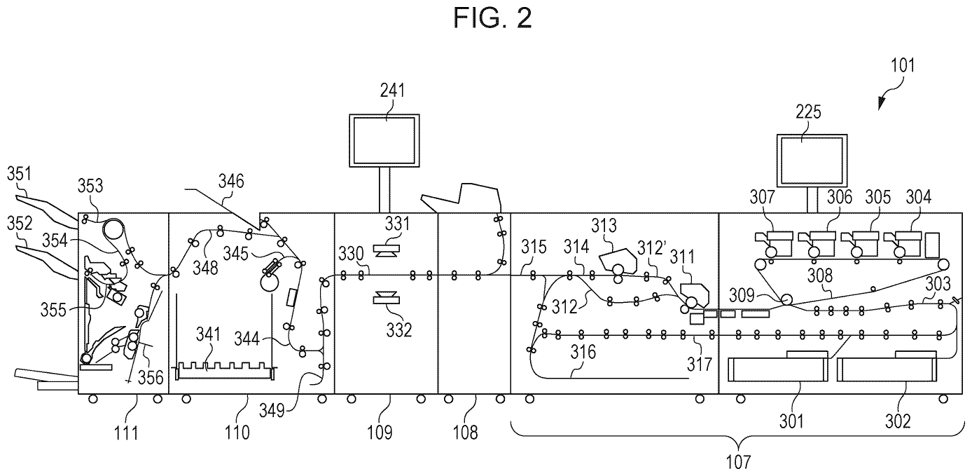

Referring to FIG. 2, an example of the hardware configuration of the image forming apparatus 101 according to the present embodiment will be described. A specific operation example of the image forming apparatus 101 will be described hereinbelow with reference to FIG. 2. In the printing unit 107, various types of recording media (paper) are contained in paper feed decks 301 and 302. At image formation, among the recording media contained in the paper feed deck 301 or 302, the uppermost recording medium is separated one by one and is fed to a conveying path 303.

Image forming stations 304 to 307 each include a photosensitive drum (a photoconductor) and form toner images on the photosensitive drums using different color toners. Specifically, the image forming stations 304 to 307 form toner images using yellow (Y), magenta (M), cyan (C), and black (K) toners, respectively.

The color toner images formed in the image forming stations 304 to 307 are laid one on another on an intermediate transfer belt 308, thereby being transferred (primary transfer). The toner image transferred to the intermediate transfer belt 308 is conveyed to a secondary transfer position 309 with the rotation of the intermediate transfer belt 308. At the secondary transfer position 309, the toner image is transferred from the intermediate transfer belt 308 to the recording medium conveyed through the conveying path 303 (secondary transfer). The recording medium after the secondary transfer is conveyed to a fixing unit 311. The fixing unit 311 includes a pressure roller and a heating (fixing) roller. By applying heat and pressure to the recording medium while the recording medium passes between the rollers, a fixing process for fixing a toner image to the recording medium is performed. The recording medium that has passed through the fixing unit 311 is conveyed, via a conveying path 312, to a connection point 315 between the printing unit 107 and the inserter 108. In this manner, a color image is formed (printed) on the recording medium.

If an additional fixing process is required depending on the type of the recording medium, the recording medium that has passed through the fixing unit 311 is guided to a conveying path 314 on which a fixing unit 313 is provided. The fixing unit 313 performs an additional fixing process on the recording medium conveyed on the conveying path 314. The recording medium that has passed through the fixing unit 313 is conveyed to the connection point 315. When a two-sided printing mode is set, the image is printed on a first surface. The recording medium conveyed to the conveying path 312 or the conveying path 314 is guided to a reversing path 316. The recording medium reversed through the reversing path 316 is guided to a duplex conveying path 317 and conveyed to the secondary transfer position 309. Thus, the toner image is transferred, at the secondary transfer position 309, to a second surface of the recording medium opposite to the first surface. Thereafter, the recording medium passes through the fixing unit 311 (and the fixing unit 313), thereby completing formation of the color image on the second surface of the recording medium. The printed recording medium, on which formation (printing) of an image is completed in the printing unit 107 and conveyed to the connection point 315, is conveyed into the precursor diagnosis unit 109 via the inserter 108.

The precursor diagnosis unit 109 includes image reading sections 331 and 332 each having a contact image sensor (CIS) on a conveying path 330 to which the printed recording medium from the printing unit 107 is conveyed. The image reading sections 331 and 332 are opposed via the conveying path 330. The image reading sections 331 and 332 are configured to read the upper surface (first surface) and the lower surface (second surface) of the recording medium, respectively. The image reading sections 331 and 332 may each be constituted by a charge coupled device (CCD) or a line scan camera, instead of the CIS.

The precursor diagnosis unit 109 is operated in accordance with an instruction to execute a precursor diagnosis process. Specifically, the instruction to execute a precursor diagnosis process may be any method that allows determination whether a precursor image diagnosis is to be executed, such as a method in which whether to execute a precursor diagnosis process is associated with the print job and a method of pressing a precursor image diagnosis execution button at the start of the print job. Alternatively, a method of automatic setting such as a method for automatically executing the precursor image diagnosis upon activation may be used. When an instruction to execute a precursor diagnosis process is issued, the precursor diagnosis unit 109 executes an image precursor diagnosis process for determining whether a precursor has occurred in the image forming apparatus 101 using a read image on a printed recording medium conveyed through the conveying path 330.

Specifically, the precursor diagnosis unit 109 executes a reading process of reading an image on the printed recording medium being conveyed using the image reading sections 331 and 332. The precursor diagnosis unit 109 then executes an image precursor diagnosis process, described later, using the image data acquired by the reading process. The recording media that have passed through the precursor diagnosis unit 109 are conveyed to the stacker 110 one by one. The application of the precursor diagnosis unit 109 is not limited to the above example. An inspection system for inspecting printed recording media for a print defect may be additionally provided.

The stacker 110 includes a stack tray 341 on which printed recording media conveyed from the precursor diagnosis unit 109, which is disposed upstream in the conveying direction of the printed recording medium, are stacked. The printed recording medium that has passed through the precursor diagnosis unit 109 is conveyed through a conveying path 344 in the stacker 110. Since the printed recording media conveyed through the conveying path 344 are guided to a conveying path 345, the printed recording media are stacked in the stack tray 341. Printed recording media that are not stacked in or discharged from the stacker 110 are conveyed to the downstream finisher 111 through a conveying path 348.

The stacker 110 further includes a reversing section 349 for reversing the orientation of the printed recording medium being conveyed. The reversing section 349 is used, for example, to align the orientation of a recording medium input to the stacker 110 with the orientation of a printed recording medium stacked in the stack tray 341 and output from the stacker 110. A printed recording medium that is conveyed to the finisher 111 without being stacked in the stacker 110 is not reversed by the reversing section 349.

The finisher 111 executes a finishing function specified by the user on printed recording media conveyed from the precursor diagnosis unit 109 disposed upstream along the conveying direction of the printed recording media. In the present embodiment, the finisher 111 has finishing functions including a staple function (one-or two-point binding), a punching function (two or three holes), and a saddle-stitch book binding function. The finisher 111 includes two paper discharge trays 351 and 352. When no finishing process is performed by the finisher 111, the printed recording media conveyed to the finisher 111 are discharged to the paper discharge tray 351 through a conveying path 353. When a finishing process such as a stapling process is performed by the finisher 111, the printed recording media conveyed to the finisher 111 are guided to a conveying path 354. The finisher 111 executes a finishing process specified by the user on printed recording media conveyed through the conveying path 354 using a finishing section 355 and discharges the printed recording media subjected to the finishing process to the paper discharge tray 352.

### Functional Configuration Diagram

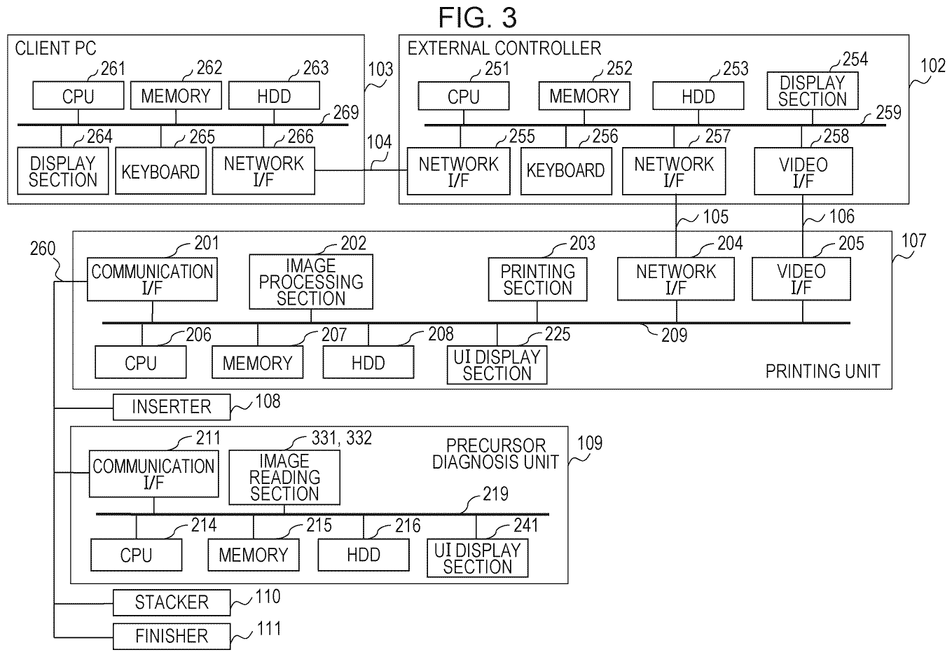

Referring to FIG. 3, the functional configuration of the image forming apparatus 101, the external controller 102, and the client PC 103 according to the present embodiment will be described. The printing unit 107 of the image forming apparatus 101 includes a communication interface (I/F) 201, a network I/F 204, a video I/F 205, a central processing unit (CPU) 206, a memory 207, a hard disk drive (HDD) 208, and a user interface (UI) display section 225. The printing unit 107 further includes an image processing section 202 and a printing section 203. These sections are connected so as to mutually transmit and receive data via a system bus 209. The communication I/F 201 is connected to the precursor diagnosis unit 109, the stacker 110, and the finisher 111 via a communication cable 260. The CPU 206 performs communication for controlling the individual devices via the communication I/F 201. The network I/F 204 is connected to the external controller 102 via the internal LAN 105 and used for communication of control data and the like.

The video I/F 205 is connected to the external controller 102 via the video cable 106 and used for communication of data including image data. The printing unit 107 (the image forming apparatus 101) and the external controller 102 may be connected only by the video cable 106 if the operation of the image forming apparatus 101 can be controlled by the external controller 102. The HDD 208 stores various programs or data. The CPU 206 controls the overall operation of the printing unit 107 by executing the programs stored in the HDD 208.

The HDD 208 stores the total number of printed sheets counted, which is used to determine whether to execute automatic recovery. The memory 207 stores programs and data that are required when the CPU 206 executes various processes. The memory 207 also serves as a work area for the CPU 206. The UI display section 225 is used to receive inputs of various settings and operations from the user and to display various information such as setting information and the processing status of a print job. For example, the UI display section 225 receives various instructions from the user, such as an instruction to execute a precursor image diagnosis, settings related thereto, and settings for paper information.

The precursor diagnosis unit 109 includes a communication I/F 211, a CPU 214, a memory 215, an HDD 216, image reading sections 331 and 332, and a UI display section 241. These devices are connected so as to mutually transmit and receive data via a system bus 219. The communication I/F 211 is connected to the printing unit 107 via the communication cable 260. The CPU 214 performs communication required to control the precursor diagnosis unit 109 via the communication I/F 211.

The CPU 214 controls the operation of the precursor diagnosis unit 109 by executing a control program stored in the memory 215. The memory 215 stores a control program for the precursor diagnosis unit 109. The image reading sections 331 and 332 read an image on a conveyed recording medium in accordance with an instruction from the CPU 214. The CPU 214 diagnoses whether a precursor has occurred in the image forming apparatus 101 based on the image for precursor diagnosis read by the image reading sections 331 and 332. The UI display section 241 is used to display the result of the precursor diagnosis and a settings screen. The UI display section 241 also serves as an operating section and is operated by the user to receive various instructions from the user, such as an instruction to change the setting of the precursor diagnosis unit 109, an instruction to execute a precursor image diagnosis and settings related thereto, and an instruction to issue a notification of the result of the precursor diagnosis and settings related thereto. The HDD 216 stores various setting information and image data required for image precursor diagnosis. The various setting information and image data stored in the HDD 216 are reusable.

The stacker 110 controls the printed recording medium conveyed through the conveying path 344 to be stacked in the stack tray 341, to be discharged to an escape tray 346, or to be conveyed to the finisher 111 connected to the downstream side in the conveying direction of the printed recording medium.

The finisher 111 controls conveyance and discharge of the printed recording medium and performs a finishing process such as stapling, punching, or saddle-stitch book binding.

The external controller 102 includes a CPU 251, a memory 252, an HDD 253, a display section 254, network I/Fs 255 and 257, a keyboard 256, and a video I/F 258. These devices are mutually connected so as to transmit and receive data via a system bus 259. The CPU 251 executes programs stored in the HDD 253 to control the overall operation of the external controller 102, such as receiving print data from the client PC 103, raster image processing (RIP), and transmitting print data to the image forming apparatus 101. The memory 252 stores programs and data that are required when the CPU 251 executes various processes. The memory 252 also serves as a work area for the CPU 251.

The HDD 253 stores various programs and data. The keyboard 256 is used to input user instructions to operate the external controller 102. The display section 254 is, for example, a display, which is used to display information relating to an application being executed and an operation screen in the external controller 102. The network I/F 255 connects to the client PC 103 via the external LAN 104 to communicate data such as print instructions. The network I/F 257 connects to the printing unit 107 via the internal LAN 105 to communicate data such as print instructions. The external controller 102 is configured to communicate with the printing unit 107, the precursor diagnosis unit 109, the stacker 110, and the finisher 111 via the internal LAN 105 and the communication cable 260. The video I/F 258 connects to the printing unit 107 via the video cable 106 to communicate data such as image data (print data).

The client PC 103 includes a CPU 261, a memory 262, an HDD 263, a display section 264, a keyboard 265, and a network I/F 266. These devices are connected so as to mutually transmit and receive data via a system bus 269. The CPU 261 controls the operation of the individual devices via a system bus 269 by executing the programs stored in the HDD 263. As a result, various processes are implemented by the client PC 103. For example, the CPU 261 generates print data and issues print instructions by executing a document processing program stored in the HDD 263. The memory 262 stores programs and data required when the CPU 261 performs various processes. The memory 262 also serves as a work area for the CPU 261.

The HDD 263 stores, for example, various applications such as a document processing program, programs such as a program for a printer driver, and various data. The display section 264 is, for example, a display, which is used to display information on an application being executed and an operation screen in the client PC 103. The keyboard 265 is used to input user instructions to operate the client PC 103. The network I/F 266 is communicably connected to the external controller 102 via the external LAN 104. The CPU 261 communicates with the external controller 102 via the network I/F 266.

### Precursor Diagnosis Process

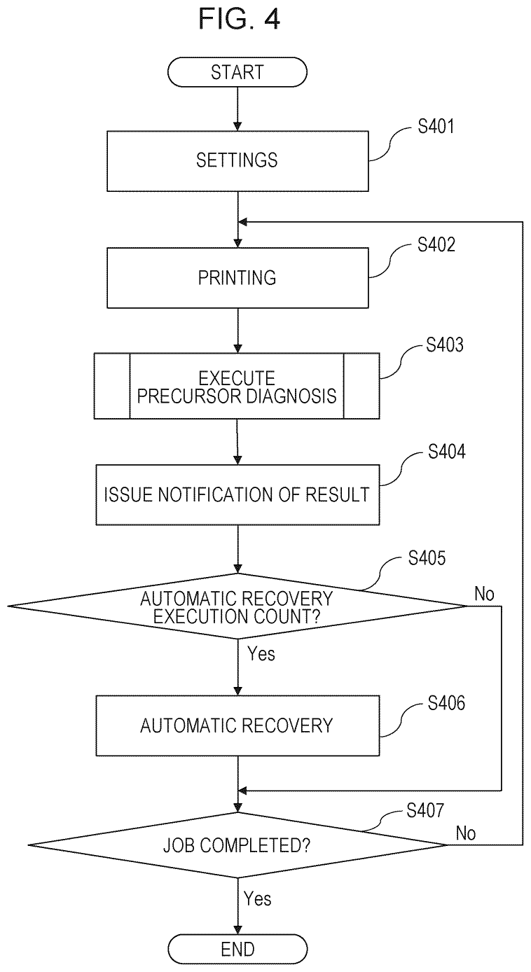

A precursor diagnosis process according to the present embodiment will be described with reference to the drawings. FIG. 4 is a flowchart illustrating the procedure of a printing operation performed by the printing unit 107 and a precursor diagnosis process performed by the precursor diagnosis unit 109. FIG. 4 illustrates an overall procedure from operations performed before starting precursor diagnosis, through execution of the precursor diagnosis, to execution of automatic recovery. Sign “S” in the description of the flowchart denotes a step. This also applies to the description of the following flowcharts. The processes of the steps in FIG. 4 are executed by the CPU 206 of the printing unit 107 and the CPU 214 of the precursor diagnosis unit 109.

At step S401, the printing system 100 receives an instruction for precursor diagnosis from a user or a service person via the UI display section 241 serving also as an operating section, and confirms settings for the precursor diagnosis process. In the present embodiment, a screen for receiving an instruction to start precursor diagnosis is displayed on the UI display section 241, and upon receiving a start instruction, settings for precursor diagnosis are made regarding an image defect level and notification of the diagnosis result.

The start instruction is not limited to the above example, provided that execution of the precursor diagnosis can be recognized. For example, the job may be associated in advance with execution of precursor diagnosis, and upon receiving the job associated with precursor diagnosis, it may be determined that an instruction to start precursor diagnosis has been issued. With respect to the settings of image defect levels, the present embodiment describes a case where the determination level for an image defect is classified into nine levels according to the size and contrast of the image defect, from which the user selects the determination level.

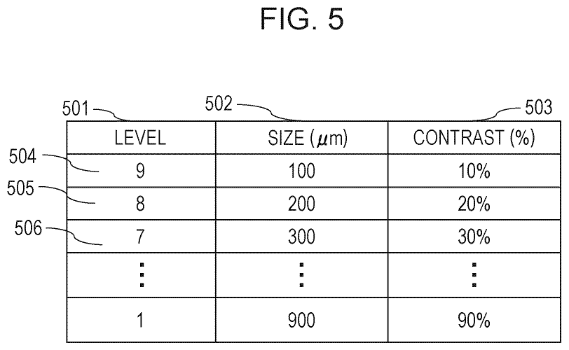

FIG. 5 illustrates an example of the image defect level. Image defect level 501 selected by the user is set such that the lower the level, the larger the size 502 of the image defect and the higher the contrast 503, whereas the higher the level, the smaller the size 502 of the image defect and the lower the contrast 503. The image defect level settings are not limited to the above example. The level 501 need only be an image defect determinable level, and only the size or only the contrast may be selected from the image defect. Alternatively, a method of setting numerical values instead of levels, or a method of selecting a sample image, may be employed. The details of the notification of the diagnosis result will be described later in Notification of Diagnosis Result.

After the settings for precursor diagnosis are confirmed and stored in the HDD 216, the process proceeds to a printing process of the print job. At step S402, a printing operation, that is, a print job, is started in response to print instructions from the client PC 103 and the external controller 102. Specifically, the CPU 251 of the external controller 102 performs PDL interpretation from the description in a PDF file of the PDF print job received at step S401, including interpreting characters in terms of font type, size, and designated positions on a sheet. Next, the CPU 251 generates RIP data rasterized into a bitmap in accordance with the resolution setting obtained from the PDL interpretation at step S402. The CPU 251 associates the RIP data with feature-extractable items. The details of the feature-extractable items will be described later.

The CPU 251 temporarily stores the generated RIP data, as a reference image, in the HDD 253 of the external controller 102 in association with diagnosable items. Thereafter, the reference image stored in the HDD 253 is sent to the precursor diagnosis unit 109 and is stored in the HDD 216 of the precursor diagnosis unit 109. Thereafter, the CPU 251 transmits the RIP data from the video I/F 258 to the video I/F 205 of the printing unit 107 through the video cable 106. The CPU 206 of the printing unit 107 performs a half-tone process on the RIP data received by the video I/F 205 and prints the half-tone processed image data in the printing section 203.

At step S403, the CPU 214 of the precursor diagnosis unit 109 executes precursor diagnosis, described later, by a precursor diagnosis execution process, and stores the execution result in the HDD 216. At step S404, the CPU 214 issues a notification of the diagnosis result according to notification details stored in the HDD 216. The present embodiment describes a case where the diagnosis result is displayed on the UI display section 241. Notification of the diagnosis result is not limited to display on the UI display section 241. The diagnosis result may be displayed on the display section 264 of the client PC, the display section 254 of the external controller, or the UI display section 225 of the printing unit 107, or alternatively, may be printed or transmitted to an external cloud or external PC via a network.

The details of the notification content will be described later in Notification of Diagnosis Result.

At step S405, the CPU 214 of the precursor diagnosis unit 109 determines whether to execute automatic recovery. In the present embodiment, the execution timing of automatic recovery is set to a number of printed sheets predicted by precursor diagnosis. The CPU 214 reads the number of printed sheets stored in the HDD 208, and when the number of printed sheets reaches the set value, executes automatic recovery. If the number is not the automatic recovery execution count (No), the process proceeds to step S407.

If the number is the automatic recovery execution count (Yes), the process proceeds to step S406, and automatic recovery is executed. The automatic recovery may be executed in accordance with an instruction of the user. In that case, the process proceeds to step S407 after completion of the process of step S404.

At step S406, the CPU 214 executes automatic recovery in accordance with the precursor diagnosis result stored in the HDD 216. After the execution of automatic recovery, the process proceeds to step S407. At step S407, the CPU 214 determines whether the job has been completed. If the job continues (No in S407), the process proceeds to step S402. If the job has been completed (Yes in S407), this processing is terminated. Examples of the automatic recovery include cleaning of the wire or grid of a corona charger serving as a photosensitive drum charging unit.

### Feature-Extractable Items

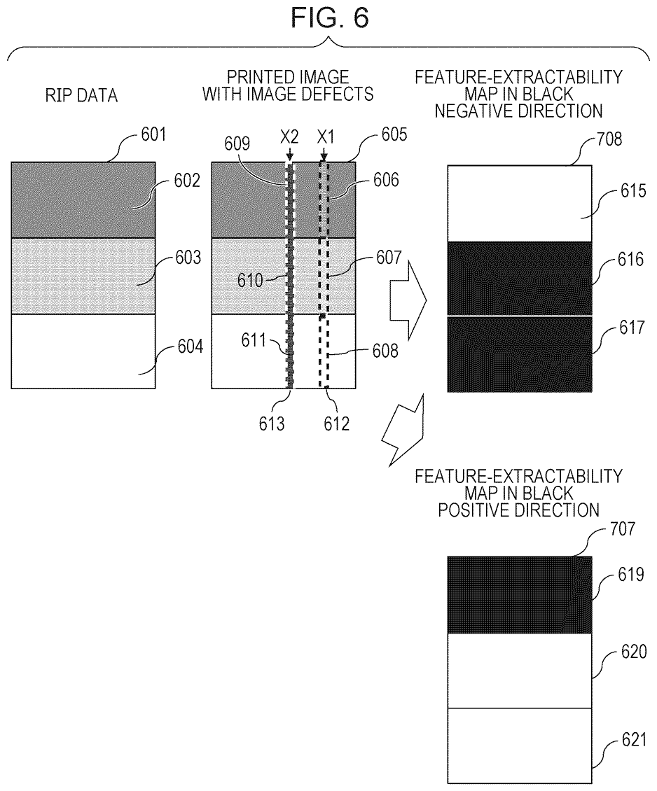

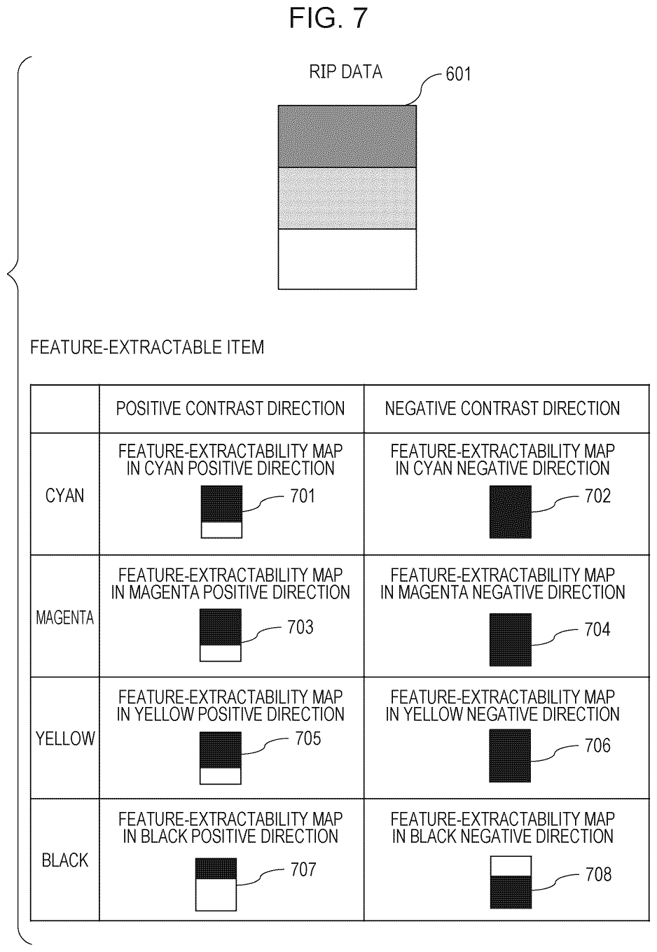

FIG. 6 is a schematic diagram illustrating settings of feature-extractable items. FIG. 7 is a diagram illustrating an example of feature-extractable items stored in association with RIP data. In the present embodiment, eight combinations are set as feature-extractable items, namely, four colors of cyan, magenta, yellow, and black, and two types of shading defect. The shading defect is defined by whether the defect has occurred in the dark direction (positive contrast direction) or in the light direction (negative contrast direction). The feature-extractable items are expressed by feature-extractability maps (701 to 708) in which a feature-extractable pixel is set to 1, and a feature-unextractable pixel is set to 0.

Assume that an image defect has occurred in an image 605 in which RIP data 601 for monochrome (black and white) printing including a dark black region 602, a light black region 603, and a white region 604 is printed. When a vertical streak 612 in a negative contrast direction has occurred in a main scanning position X1, an image defect appears in a dark black region 606 but does not appear in a white region 608 and a light black region 607. The feature in the black negative contrast direction can be extracted from regions where the black density is at or above a predetermined level.

Accordingly, the feature-extractability map 708 in the black negative contrast direction is stored such that pixels where the black density is higher than 40% are set to 1 as a diagnosable region (615), and the other pixels are set to 0 as feature-unextractable regions (616 and 617). When a vertical streak 613 in a positive contrast direction has occurred in a main scanning position X2, the vertical streak appears in a white region 611 and a light black region 610 but does not appear in a dark black region 609. The feature in the black positive contrast direction can be extracted from regions where the black density is at or below a predetermined level.

Accordingly, the feature-extractability map 707 in the black positive contrast direction is stored such that pixels where the black density is equal to or lower than 60% are set to 1 as diagnosable regions (620 and 621), and the other pixels are set to 0 as a feature-unextractable region (619).

It is impossible to extract features in the cyan, magenta, and yellow negative (white) directions from the monochrome RIP data 601 for white-and-black printing. Accordingly, in the case of monochrome RIP data, the feature-extractability maps 702, 704, and 706 in the negative contrast direction of cyan, magenta, and yellow are stored as feature-unextractable items. Furthermore, feature-extractability maps 701, 703, and 705 in the positive contrast direction of cyan, magenta, and yellow are stored such that only the white region 604 without black is feature extractable.

The setting of diagnosable items is not limited to the above color and contrast direction, but may also be based on area or flatness. Furthermore, the method is not limited to a map format, and any method may be employed that allows feature extractable regions to be identified. For example, instead of making a determination for each pixel, RIP data may be divided into multiple blocks, and whether each block is diagnosable may be set.

### Precursor Diagnosis Execution Process

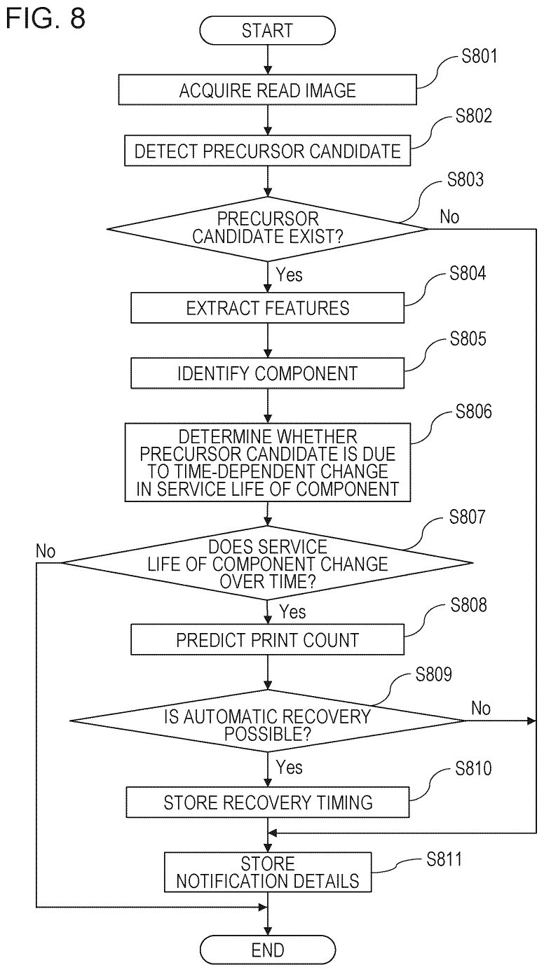

The precursor diagnosis process of S403 according to the present embodiment will be described in detail with reference to FIG. 8. FIG. 8 is a flowchart illustrating the procedure of an image precursor diagnosis process executed by the precursor diagnosis unit 109. FIG. 8 shows the flow of the precursor diagnosis process. The processes of the steps in FIG. 8 are executed by the CPU 214 of the precursor diagnosis unit 109.

At step S801, the CPU 214 executes a process of reading a recording medium using the image reading sections 331 and 332. The read image on the determination target recording medium is stored in the HDD 216 of the precursor diagnosis unit 109 as a precursor diagnosis target image. When the precursor diagnosis target image is stored, the process proceeds to step S802.

At step S802, the CPU 214 detects a precursor candidate to determine the precursor of a defect in the printing unit 107 by comparing the reference image with the precursor diagnosis target image. In the present embodiment, the reference image and the precursor diagnosis target image are compared to calculate the difference therebetween, thereby detecting a precursor candidate. A correction unit may be provided to correct the nonlinearity between the signal value and the luminance of the precursor diagnosis target image obtained by the image reading sections 331 and 332, and the signal value of the precursor diagnosis image may be corrected, and thereafter, difference image data may be calculated. If the calculated difference value exceeds a threshold, it is determined that a difference exists, and a value of 1 is written into the difference image data. In contrast, if the difference value falls below the threshold, a value of 0 is written into the difference image data.

In the present embodiment, the threshold is set smaller in size and lower in contract than the level set at step S401. For example, if at step S401 level 7 (506 ) (size: 300 μm, contrast: 30%) is set as an image defect, level 9 (504 ) (size: 100 μm, contrast: 10%) is set as the detection threshold. The difference image data, which is binary data indicating whether a difference exists, is stored in the HDD 216, and the process proceeds to step S803.

Upon completion of generating the difference image data, at step S803, the CPU 214 determines whether a precursor candidate has occurred. The determination is made based on whether the difference image data includes data including a value of 1. If the CPU 214 determines that no precursor candidate has occurred (No in step S803), the processing ends. In contrast, if the CPU 214 determines that a precursor candidate has occurred (difference image data includes a value of 1) (Yes in step S803), the process proceeds to step S804.

At step S804, the CPU 214 extracts feature values for identifying a component in which a precursor candidate of a defect in the printing unit 107 has occurred and predicting a failure timing from the precursor diagnosis target image data, the difference image data, and diagnosable items associated with the reference image. At step S802, the CPU 214 extracts features of the difference from a precursor diagnosis target image corresponding to a reference region determined to have “difference”, calculated from the difference image data, and the diagnosable items. In this feature extraction process, for example, coloring material information and contrast information are obtained in accordance with the diagnosable items. The coloring material information is information obtained from the difference image and indicates in which of yellow, magenta, cyan, and black the precursor candidate has occurred. The contrast information indicates the contrast of the precursor candidate in the positive direction or the negative direction as a positive value or a negative value. At that time, colors, a positive contrast direction, and a negative contrast direction that are not set in the diagnosable items determined from the RIP data are not extracted as features.

Furthermore, the CPU 214 obtains size information on the precursor candidate, such as the width (in the main scanning direction) and the height (in the sub-scanning direction) and shape information such as a dot shape, a vertical streak shape, and a horizontal streak shape. In the present embodiment, the shape information is obtained from the aspect ratio of the width to the height of the obtained size information. Specifically, when the aspect ratio obtained by dividing the width by the height exceeds a predetermined threshold, the shape is determined to be a horizontal streak. When the aspect ratio is equal to or less than the threshold, the shape is determined to be a vertical streak, and for a shape not falling into either category, it is determined to be a dot. The method for obtaining the shape information is illustrative only. Any method may be employed that allows acquisition of the shape of the precursor, such as a dot, a horizontal streak, or vertical streak. For example, a shape having a width of a threshold or more may be determined to be a horizontal streak, a shape having a height of a threshold or more may be determined to be a vertical streak, and the other shape may be determined to be a dot. Furthermore, coordinate information indicating the direction perpendicular to the conveying direction of the recording medium in the printing unit 107 is also used as a feature.

At step S805, the CPU 214 identifies a component causing a precursor candidate in the image reading section 331 and the printing unit 107 based on the feature information of the difference region obtained at step S804. In the case of a dot or a horizontal streak, the CPU 214 selects a combination in the same color and with high similarity from the difference region, and identifies a component in which a precursor has occurred based on the cycle of the selected combination.

The present embodiment describes a case where a combination with high similarity is determined using a known template matching technique. Images of precursor candidates are compared by template matching, and the highest value is used as the similarity between the precursor candidates. A combination of precursors whose calculated similarity is equal to or higher than a predetermined threshold is determined to have high similarity. The similarity determination method is illustrative only. Any method may be employed that allows determination of whether the precursor candidates are similar. For example, a method of determining the similarity between images using machine learning or a method of calculating the similarity between precursor candidate images by comparing the feature values and features may be employed.

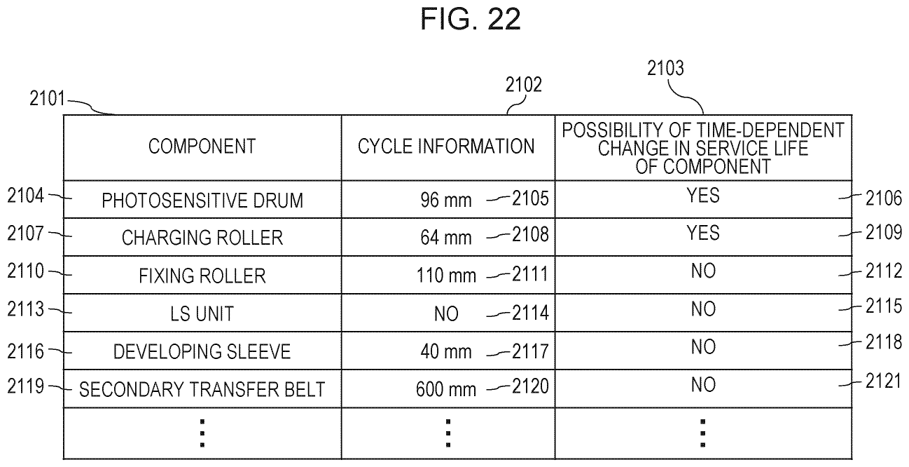

Next, the distance between the similar precursor candidates in the sub-scanning direction is calculated, and if the distance is a multiple of the cycle of a certain component, the component is identified as the precursor-occurring component. A cyclic precursor has a characteristic of cyclically occurring at the same main scanning position and in the same color with respect to the precursor-occurring component. For example, a cycle correspondence table in which components correspond to cycle information is prepared. FIG. 22 illustrates an example of the cycle correspondence table. Component 2101 that corresponds when the cycle is a multiple of the cycle distance in cycle information 2102 is identified as the causal component. Specifically, when the distance between similar precursor candidates in the sub-scanning direction is 96 mm or 198 mm, which is a multiple of 96 mm (2105), a photosensitive drum 2104 is determined to be the causal component. The multiples of the cycle distance and the distance between similar precursor candidates in the sub-scanning direction do not need to completely agree, allowing for margins. If it is difficult to identify the causal component using the cycle information 2102, or in the case of vertical streaks that continue to occur at the same main scanning position, the component is identified using feature information such as size or contrast. A line scan (LS) unit 2113 is one example, in which its cycle information 2114 is “No”, and vertical streaks occur.

The method for identifying the component is illustrative only. Any method that can identify the cause may be employed, such as a method using machine learning or a method of identifying the cause by comparing with previous data stored in a database. When feature information is insufficient, and the cause cannot be identified, the cause need not be limited to a single one, and multiple candidate causes may be obtained. After the cause is identified, the current print count stored in the HDD 208 is read, the extracted feature and the component are associated and stored in the HDD 216, and the process proceeds to step S806.

At step S806, the CPU 214 executes a process of determining whether the precursor candidate is due to a time-dependent change in the service life of the component (whether it is a precursor or an image defect not due to a time-dependent change in the service life of the component). The details of the process of determining a time-dependent change in the service life of the component will be described later. The CPU 214 stores the result of determination in the HDD 216. For example, if the service life of the component changes over time, 1 is stored, and if the service life of the component does not change over time, 0 is stored. However, this method is merely illustrative; any method may be employed that enables determination of whether the service life of the component changes over time.

At step S807, the CPU 214 determines whether the precursor candidate is due to a time-dependent change in the service life of the component, based on the determination result stored in the HDD 216 at step S806. If the service life of the component does not change over time (No in S807), this processing ends. If the service life of the component changes over time (Yes in S807), the process proceeds to step S808.

At step S808, the CPU 214 predicts a print count until an image defect level based on the causal component identified at step S805, the size and contrast of the precursor, the feature information on the past precursors stored in the HDD 216, and a component failure-timing prediction table. The details of the prediction method will be described later in Predicting Failure Timing. The predicted print count is stored in the HDD 216, and the process proceeds to step S809.

Next, at step S809, the CPU 214 determines whether automatic recovery is possible. Examples of cases where automatic recovery cannot be performed include a case where user intervention is required, such as cleaning the reading glass surface of the image reading sections 331 and 332 of the precursor diagnosis unit 109 and adjusting the recording media to be used, and a case where service personnel intervention is required, such as replacing the component. Further examples of cases where automatic recovery cannot be performed include reading errors of the image reading sections 331 and 332 and fibers or foreign substances contained in the recording media before image formation. If automatic recovery cannot be performed, the process proceeds to step S811.

Automatically recoverable items are items that can be automatically recovered, using a charger cleaning mechanism (not shown), by the printing unit 107, such as cleaning the wires and grids of the corona charger serving as a charging unit for the photosensitive drums provided in the image forming stations 304 to 307 of the printing unit 107. If automatic recovery is possible, the process proceeds to step S810.

At step S810, the CPU 214 stores the details of automatic recovery in the HDD 216 in association with the print count until the image defect level stored in the HDD 216. For example, when a precursor has occurred in a corona charger serving as a charging unit for the photosensitive drum, cleaning of the wires of the corona charger is stored as the details of the automatic recovery. Upon completion of the storage, the process proceeds to step S811.

At step S811, the CPU 214 stores the diagnosis result for notification in the HDD 216. If there is no precursor candidate, a status indicating no problem is stored. If there is a precursor candidate, a predicted print count and feature information are stored. Upon completion of the storage, this processing ends. If the result at step S803 is No, then upon completion of step S808 or S809, the processing shown in FIG. 8 is terminated.

### Process of Determining Time-Dependent Change in Service Time of Component

The details of the process of determining a time-dependent change in the service life of the component at step S806 will be described. A precursor occurs due to scratches, contaminations, or deterioration of a component, and the service life of the component changes over time (as printing proceeds) to cause a print defect. Accordingly, a precursor has a characteristic of appearing repeatedly and indicating that the service life of the component is gradually approaching its end. However, depending on the material of the causal component of the print defect or the cause of occurrence of the defect, some components may not exhibit a time-dependent change in service life even if the print count increases, or there may be sudden defects. For this reason, it is necessary to determine, based on the detected precursor candidate, whether the defect is actually a precursor, and to perform processing accordingly. In the present embodiment, an example is described in which it is determined for each component whether its service life changes over time.

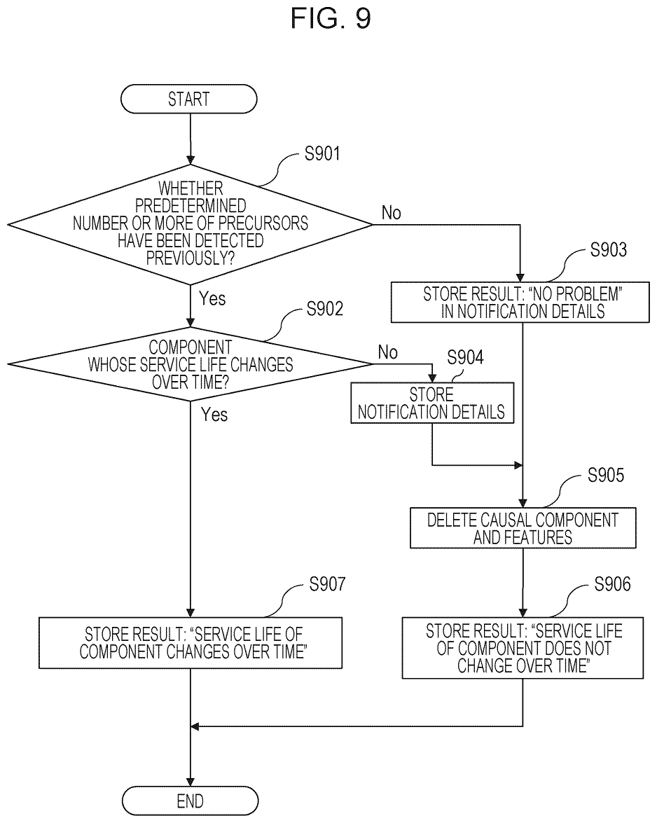

FIG. 9 is a flowchart illustrating the procedure of the process of determining a time-dependent change in the service life of the component. The processes of the steps in FIG. 9 are executed by the CPU 214 of the precursor diagnosis unit 109. At step S901, the CPU 214 determines whether a predetermined number or more of precursors has been detected. This is performed to determine whether the precursor candidate is a sudden defect. Since a precursor is characterized by appearing repeatedly, a sudden defect is determined not to be a precursor. The count may be the number stored in advance in the HDD 216 or may be provided as an external input. Different counts may be set for individual components. If a predetermined number or more of defects appears (Yes in S901), the process proceeds to step S902. If the defect is a sudden defect (No in S901), the process proceeds to step S903.

At step S902, the CPU 214 determines, in accordance with the causal component stored in the HDD 216 through the component identification process of S805, whether the service life of the component changes over time. The CPU 214 compares a component list stored in advance in the HDD 216 with the causal component. FIG. 22 shows an example of the correspondence list of causal components and the possibility of a time-dependent change in the service life of each component. If the possibility of a time-dependent change in the service life of the component, 2103, of the causal component of the precursor candidate is “No”, the CPU 214 determines that the defect is not due to a time-dependent change in the service life of the component.

For example, the respective possibilities of time-dependent changes in the service life of the component, 2112, 2115, 2118, and 2121, of the fixing roller 2110, the LS unit 2114, the developing sleeve 2116, and the secondary transfer belt 2119 exhibit “No”. Therefore, the CPU 214 determines that the fixing roller 2110, the LS unit 2114, the developing sleeve 2116, and the secondary transfer belt 2119 do not change in the service life over time.

If the CPU 214 determines that the component does not change in service life over time, the process proceeds to step S904. If the possibility 2103 of a time-dependent change in the service life of the causal component of the precursor candidate is “Yes”, the CPU 214 determines that the service life of the component changes over time. Since the possibility 2106 of a time-dependent change in the service life of the photosensitive drum 2104 and the possibility 2109 of a time-dependent change in the service life of the charging roller 2107 exhibit “Yes”, the CPU 214 determines that the service life of the components changes over time, and the process proceeds to step S907.

At step S903, the CPU 214 stores, in the HDD 216, a notification that the defect is a sudden defect and has no problem. Among precursor candidates, a sudden defect is determined by the user not to be a print defect and is unlikely to appear again, and requires no particular countermeasures. Accordingly, the CPU 214 issues a notification that the defect has no problem.

At step S904, the CPU 214 stores, in the HDD 216, the notification details of the defect that does not change in the service life of the component over time but appears repeatedly. A precursor candidate not due to a time-dependent change in service life is not determined to be “not good (NG)” at the current setting level. However, if the set level is raised, it can be determined to be “NG”. Therefore, the inspection level at which “NG” occurs is stored as notification details. In the present embodiment, a case where the inspection level at which “NG” occurs will be described. The level at which a precursor is determined to be an image defect is calculated based on the size and contrast of feature information. If the level is changed to that level, a notification indicating that an image defect will occur is stored. Upon completion of the storage, the process proceeds to step S905.

At step S905, the CPU 214 deletes the causal component and the feature information. The CPU 214 deletes the causal component and feature information stored in the HDD 216. Upon completion of the deletion, the process proceeds to step S906.

At step S906, the CPU 214 stores, in the HDD 216, the result of the determination of a time-dependent change in the service life of the component: “the service life of the component does not change over time”. For example, the CPU 214 stores, in binary form, whether the service life of the component changes over time. If the service life of the component changes over time, the result of the determination of a time-dependent change in the service life of the component is represented by “1”; and if the service life of the component does not change over time, the result is represented by “0”. In other words, the CPU 214 stores “0” as the result of the determination of the time-dependent change in the service life of the component.

At step S907, the CPU 214 stores, in the HDD 216, the result of the determination of the time-dependent change in the service life of the component: “the service life of the component changes over time”. The CPU 214 stores “1” as the result of the determination of a time-dependent change in the service life of the component. Upon completion of the process of step S906 or S907, the processing shown in FIG. 9 ends.

### Predicting Failure Timing

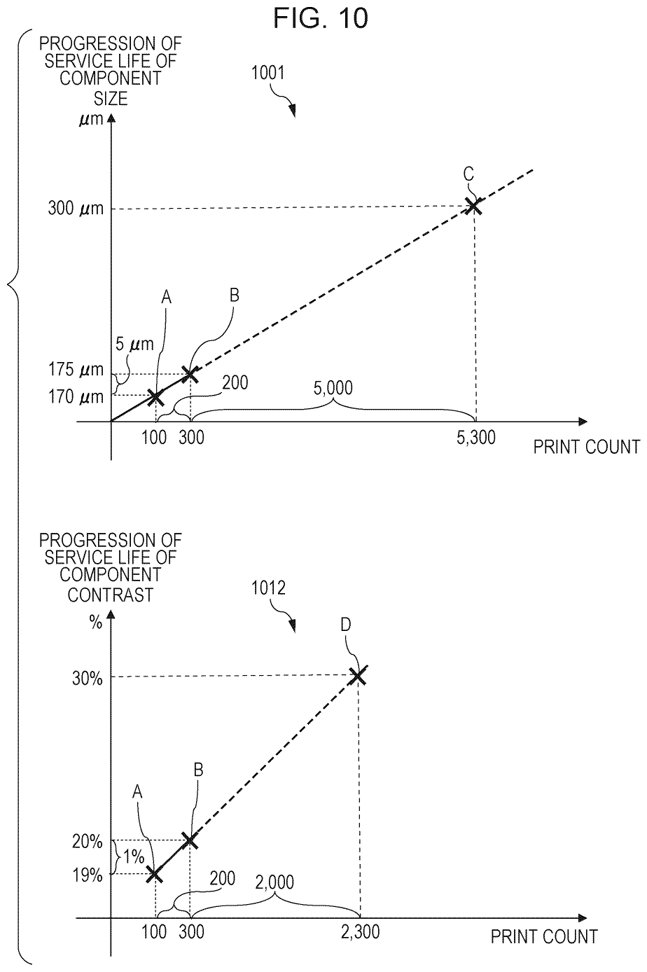

Prediction of a failure timing at step S808, at which an image defect occurs, will be described. In the present embodiment, the number of prints until an image defect occurs is predicted based on the size and contrast information of the precursor of the same component stored in the HDD 216 at the previous precursor diagnosis. A method for predicting the number of prints until an image defect occurs from the transition of the size and contrast of detected precursors will be described with reference to FIG. 10.

For example, assume that, at a print count of 300 in the current precursor diagnosis result, a precursor B has occurred at the black photosensitive drum, with a size of 175 μm and a contrast of 20%. When information on a precursor A that has occurred at the black photosensitive drum, with a size of 170 μm and a contrast of 19%, a print count of 100 is stored in the previous precursor diagnosis, the size has decreased by 5 μm, and the contrast has decreased by 1% after 200 more prints.

Assume a case where the service life of the component decreases in proportion to the print count. When the image defect level set at step S401 is level 7 (506), the image defect occurs at a size of 300 μm and a contrast of 30%. In terms of size, it is predicted that the precursor B will transition to an image defect C after 5,000 more prints, whereas in terms of contrast, it is predicted that the precursor B will transition to an image defect D after 2,000 more prints.

Assuming that the precursor B will reach the image defect level when either size or contrast is at or above the image defect level. Since the contrast will reach the image defect level after 2,000 more prints, the predicted print count until the image defect occurs is 2,000. Accordingly, since the current print count is 300, it can be predicted that the precursor B will transition to the image defect level at a print count of 2,300 after 2,000 more prints. The prediction is not limited to only one past instance, and may also be made by drawing an approximation curve based on progressions over multiple past instances.

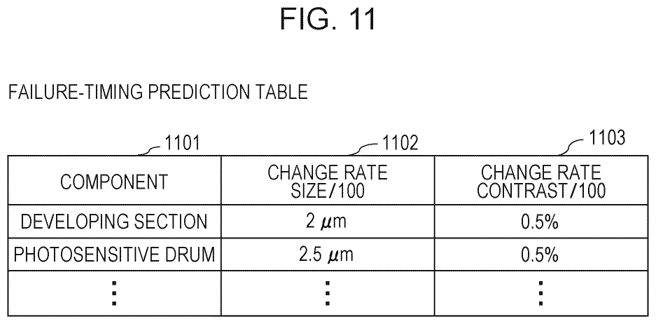

The CPU 214 stores, in the HDD 216, the result of the prediction of the number of prints until the image defect level, and the process proceeds to step S809. Alternatively, the print count and the rate of change in size and contrast may be previously stored for each component for reference. A case where a component failure-timing prediction table is previously held will be described. FIG. 11 illustrates an example of the prediction table.

As shown in FIG. 11, the prediction table stores how much the size 1102 and contrast 1103 of the component 1101 change per 100 prints. For example, assume that a precursor has occurred at a black photosensitive drum, with a size of 175 μm and a contrast of 20%, and level 7 (506) is set as an image defect level.

The precursor reaches the image defect level, i.e., a size of 300 μm and a contrast of 30%, when the size changes by 300 μm−175 μm=125 μm and the contrast changes by 30%−20%=10%. The photosensitive drum changes in size by 2.5 μm and contrast by 0.5% per 100 prints. Accordingly, in terms of size, an image defect occurs at the timing of 125 μm/2.5 μm×100=5,000 more prints, whereas in terms of contrast, 10%/0.5%×100=2,000 more prints.

Assuming that the precursor has reached the image defect level when either size or contrast reaches the image defect level, the precursor reaches the image defect level after 2,000 more prints. Assuming that the current print count is 300, it can be predicted that the image defect level will be reached at a print count of 2,300, after 2,000 more prints. When a defect component cannot be identified and multiple defect component candidates exist, the component may be identified by comparing the changes in the size and contrast of the precursor with those of each component. By comparing the calculated change with the previously stored change rate of each component, the precursor is identified as the precursor of the component whose change is the closest.

A method for prediction may be any method that enables prediction of the number of additional prints until the image defect level is reached, based on the detected precursor. A method may also be employed in which the number of additional prints until the image defect occurs is predicted by machine learning, using a precursor image, feature quantity, and the image defect level as inputs.

### Notification of Diagnosis Result

The settings for notification of diagnosis result at step S401 and the details of the notification of the result at step S404 will be described. At step S401, the CPU 214 performs settings for notification of the result and stores the settings in the HDD 216. The details of notification of the result stored in the HDD 216 at step S404 in accordance with the settings stored in the HDD 216 at step S401 will be described.

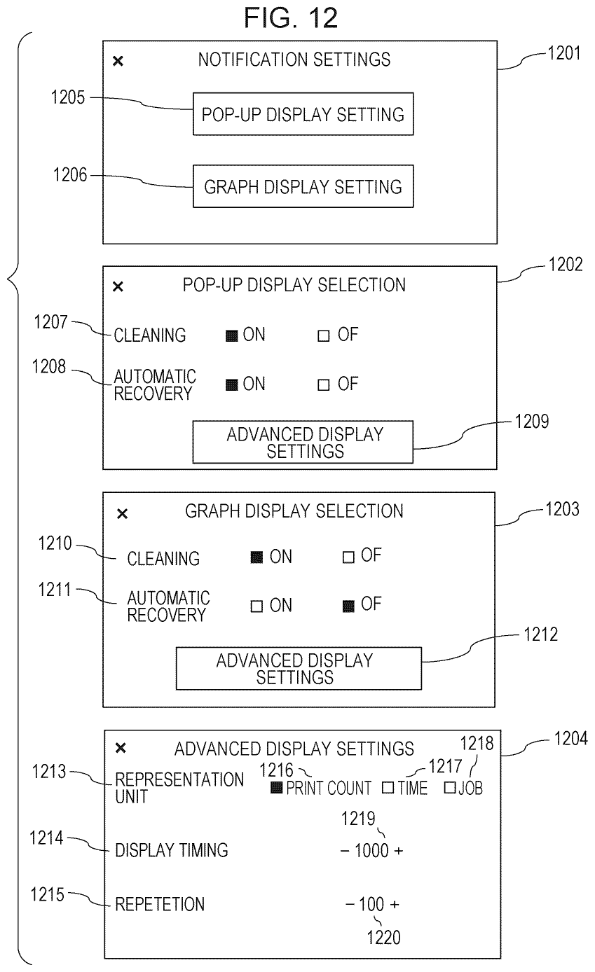

Settings for result notification at step S401 will be described with reference to FIG. 12. Displays 1201, 1202, 1203, and 1204 in FIG. 12 are schematic diagrams of setting screens displayed on the UI display section 241. The display 1201 is a result notification setting screen. In the present embodiment, the notification method includes a pop-up display and a graph display, in which the display contents can be set. The user can perform settings for each display on the display 1201, by pressing a button 1205 for the pop-up display setting or a button 1206 for the graph display setting. When the button 1205 is pressed, the display 1201 shifts to a pop-up display selection screen of the display 1202. When the button 1206 is pressed, the display 1201 shifts to a graph display selection screen of the display 1203. Depending on the cause of the precursor, the corresponding countermeasure may be either automatic recovery or cleaning by the user. For each corresponding countermeasure, it is possible to select whether to display the graph display or the pop-up display. On the setting screens of the displays 1202 and 1203, the display for cleaning items 1207 and 1210 can be switched on and off by checking the corresponding checkboxes. The display for automatic recovery items 1208 and 1211 can also be switched on and off by checking the corresponding checkboxes.

Buttons 1209 and 1212 are advanced settings buttons, and when pressed, the displays 1202 and 1203 shift to the display 1204, where the details of display can be set. The display 1204 for advanced display settings enables a display unit item 1213 to be set by checking the checkboxes for a print count item 1216, a time item 1217, and a job item 1218. A display timing item 1214 is used to provide a notification when the NG timing reaches a set print count or less by setting a numerical value 1219 with plus and minus buttons according to the unit of the display unit item 1213. A repetition item 1215 enables the timing of issuing a notification of repetition to be set by setting a repetition timing item 1220 with positive and negative signs according to the unit of the display unit item 1213.

The numerical values 1219 and 1220 are not limited to being set by the plus and minus buttons, and may also be entered directly as numerical values. These numerical values include preset values for each unit selected by the display unit item 1213. The preset values may be set in accordance with the unit checked in the display unit item 1213. The numerical values may have upper and lower limits for each unit. The upper limit and the lower limit may be set such that values exceeding them cannot be set. The details set by these settings are stored in the HDD 216.

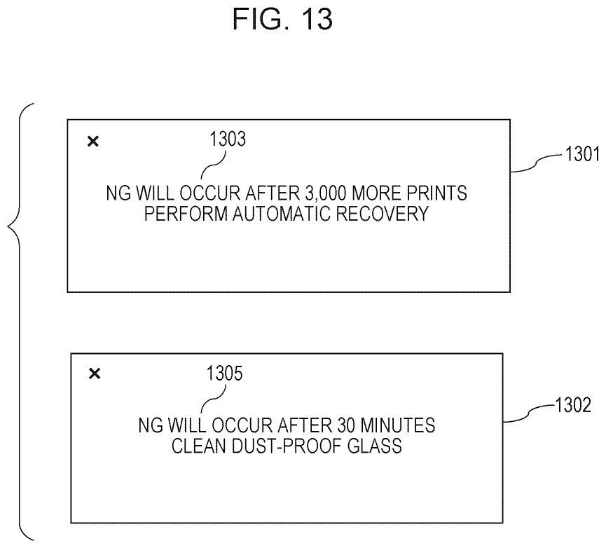

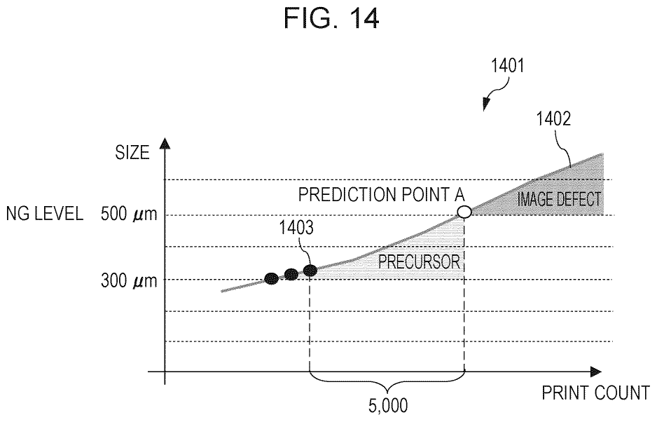

At step S404, the CPU 214 issues a notification according to the configuration details and notification details stored in the HDD 216. The CPU 214 displays the notification details on the UI display section 241 according to the notification details except when a precursor is detected. When a precursor is detected, the CPU 214 issues notification details in accordance with the notification settings set at step S401. FIGS. 13 and 14 are diagrams illustrating examples of notification display. The CPU 214 determines a display timing based on the numerical value of the display timing item 1214, and when the predicted print count stored in the HDD 216 is equal to or less than the print count displayed in the display timing item 1214, the precursor detection result is displayed. If the predicted print count is greater than the set count displayed in the display timing item 1214, no notification regarding the precursor is provided, and it is determined that no precursor has been detected. If a plurality of precursors is detected, or if a precursor and a defect not due to a time-dependent change in the service life of the component are detected, they may be displayed side by side. Alternatively, only a defect representing the first NG timing may be displayed as a representative, and the other diagnosis results may be switched after the advanced settings button is pressed.

FIG. 13 is a diagram illustrating examples of the pop-up display. When the checkbox for an item 1207 or 1208 on the display 1202 is set to ON, the precursor detection result is displayed as shown in a display 1301 or 1302. When the item 1208 for automatic recovery on the display 1202 is set to ON and the item 1216 for print count on the display 1204 is checked, the print count and a countermeasure is displayed in a message 1303 indicating the timing of occurrence of an image defect.

The countermeasure is, for example, execution of automatic recovery. When the item 1207 for cleaning on the display 1202 is set to ON, and the item 1217 for timing on the display 1204 is checked, the timing and a component that requires cleaning are displayed in a message 1305 indicating the timing of occurrence of an image defect.

FIG. 14 is a diagram illustrating an example of the graph display. When the checkbox for the item 1210 or 1211 on the display 1203 for graph display settings is checked, the precursor detection result is displayed as shown in a display 1401. In the present embodiment, a change prediction curve 1402 is calculated from the transition of the detected precursor size, and the timing of prediction point A at which the precursor reaches an image defect size of 500 μm is displayed. The indicator for determining an image defect is not limited to size; any indicator representing the degree of change in the service life of the component may be employed, including contrast and severity ranking.

If the print count 1216 on the display 1204 is checked, the horizontal axis indicates the print count, and an image defect (NG) is predicted to occur at the prediction point A, 5,000 prints after the current print count 1403.

A method for notification of the diagnosis result is merely illustrative. Any method for notification of the result may be employed; a method of displaying the result when a precursor diagnosis result button is pressed may be employed. The presentation is not limited to graphs or pop-ups; time-series, per-component listings, or tables may be employed. Upon selecting a precursor or component item from the list, the system may transition to a detailed information view or a graph view. For ease of identification, different colors may be used to display the items.

### Modification 1

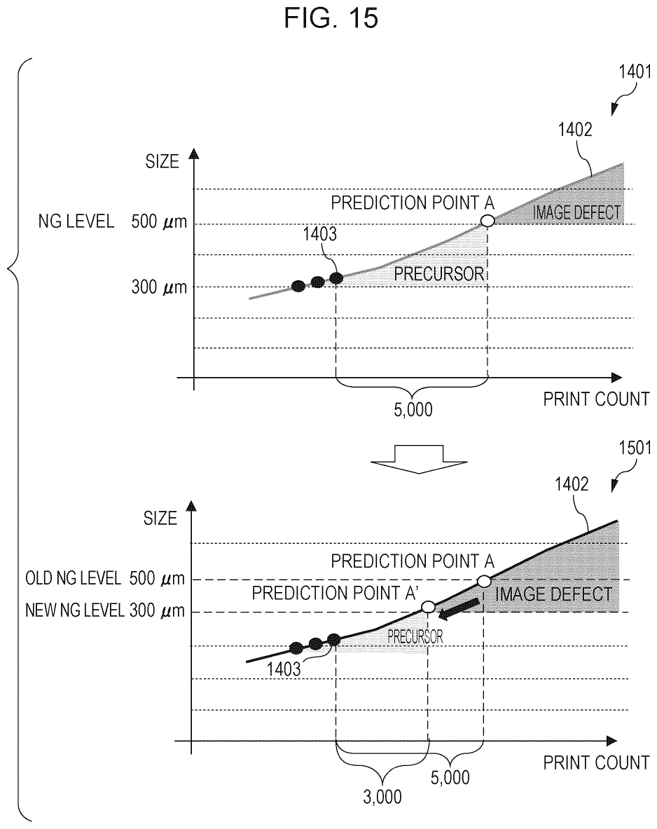

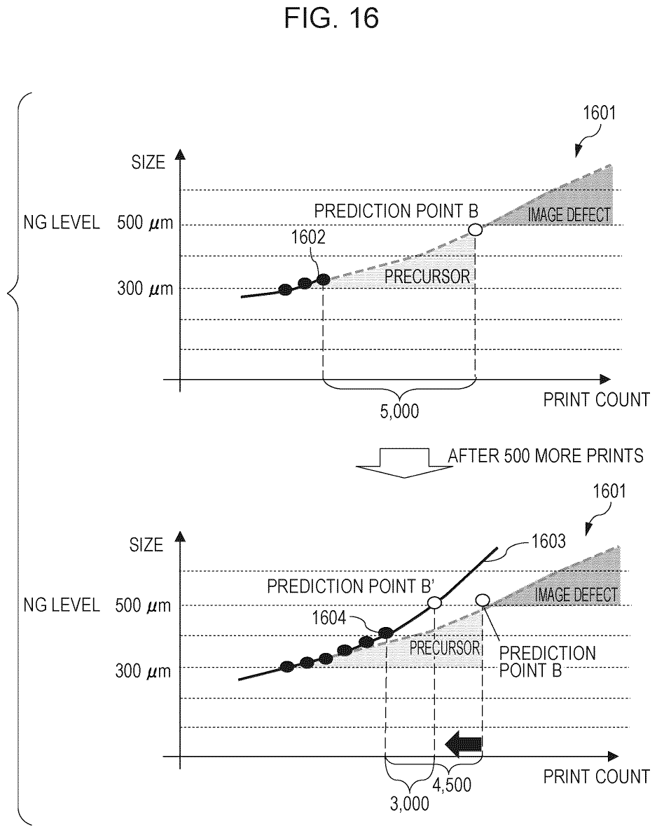

The first embodiment shows an example in which a diagnosis result is provided according to diagnosis result notification settings. However, there are cases where the provided NG timing varies significantly when the print level is changed or the speed of the change in the service life of the component varies as the print count increases. Variations in NG timing will be described with reference to FIGS. 15 and 16. FIG. 15 is a diagram illustrating NG timing when the NG level is changed. At time 1403, an NG timing prediction point A at an NG level of 500 μm, predicted using a service life curve 1402 of the component is 5,000. However, when the NG level is changed to 300 μm, the NG timing changes to 3,000 at a prediction point A′.

FIG. 16 is a diagram illustrating a case where the prediction point changes as the print count increases. At time 1602, the NG timing predicted using a service life curve 1601 of the component is 5,000 prints more after a prediction point B. However, on a service life curve 1603 of the component at time 1604 after 500 more prints, the change in the service life of the component has progressed beyond the prediction, and the NG timing has changed to prediction point B′. In the transition to the prediction point B, it is predicted that the NG timing comes after 4,500(5,000-500) more prints, whereas the change to the prediction point B′ causes a NG timing after 3,000 more prints. In this manner, a substantial deviation between the predicted NG timing and the timing indicated in a prior notification may cause user confusion. Accordingly, an example of issuing a change notification upon detecting a change will be described.

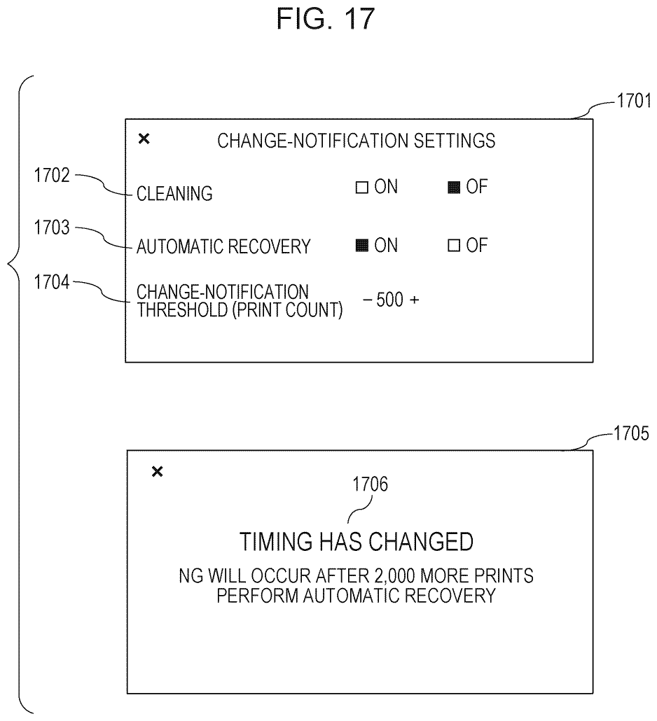

FIG. 17 is a schematic diagram illustrating change-notification settings and a notification of change details. The CPU 214 sets a notification when a change is detected in the precursor diagnosis settings at step S401 and stores the settings in the HDD 216. At step S404, the CPU 214 provides a notification of the change according to the configuration details stored in the HDD 216.

The change notification settings are input on a notification settings screen 1702. The change notification is set by checking the checkbox on and off for each of the items of cleaning 1702 and automatic recovery 1703.

A change-notification threshold 1704 can be set to specify the degree of change at which a notification is issued. In the present embodiment, the print count can be set with a plus/minus (±) value. The change-notification threshold 1704 may be displayed according to the unit specified by the display unit 1213 of the advanced settings 1204 at step S401, or the unit or the amount may be selected or input by the user.

Pop-up display of the change notification on a change display 1705 will be described. By displaying a change in NG timing as in a message 1706, the user is notified of the change in NG timing. The notification need only indicate that a change has occurred; for example, the change may be shown in a graph view. The pre-change timing and the post-change timing may be displayed together.

### Modification 2

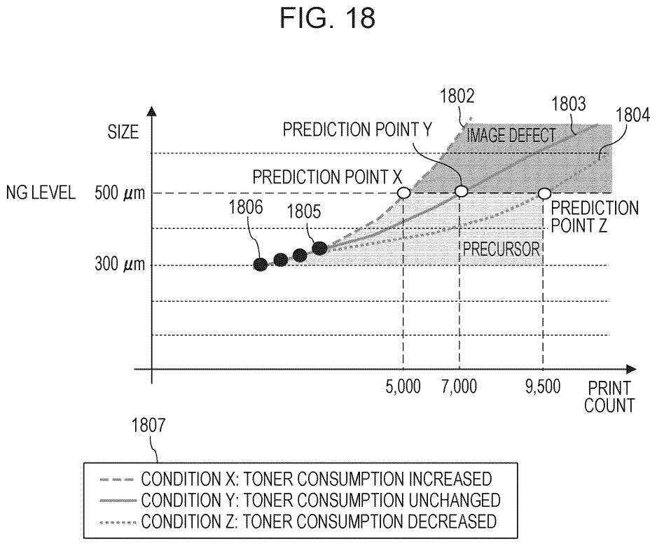

The first embodiment describes a case where the NG timing is predicted based on the progression of the service life of the causal component of a previously detected precursor. However, the change rate of the service life of the component of the precursor also changes depending on the details of the job and the environment. FIG. 18 is a diagram illustrating an example in which the change rate of the service life of the component varies depending on printing conditions.

Assume that a precursor has occurred in a magenta photosensitive drum. A service life curve 1803 of the component represents a transition estimated from the detection history of precursors detected between a past detection time point 1806 and the current time point 1805. By contrast, service life curves 1802 and 1804 of the component indicate variations in the change rate of the service life of the component when the amount of magenta toner used differs from historical levels.

The service life curve 1802 of the component represents a case where future magenta toner consumption is high, in which the change rate of the service life of the component is higher than that of the service life curve 1803 of the component. Accordingly, the predicted NG timing advances from 7,000 prints at a prediction point Y to 5,000 prints at a prediction point X. In contrast, the service life curve 1804 of the component predicted when the amount of toner used is small, the change rate of the service life of the component is lower than that of the service life curve 1803 of the component.

Accordingly, the predicted NG timing is at 9,500 prints at a prediction point Z. In this manner, the change rate of the service life of the component differs depending on printing conditions such as toner consumption and environmental conditions such as humidity information. In such cases, when a failure timing is predicted under the same conditions as the past conditions, the NG timing prediction accuracy will be decreased. Accordingly, by displaying, side by side, the service life curves 1802, 1803, and 1804 of the component under multiple conditions such as in condition 1807, it becomes possible to provide a notification of a predicted NG timing when the conditions change.

Additionally, a checkbox may be provided for each condition 1807, and the display of the service life curves 1802 to 1804 of the component may be switched. The service life curves of the component need not be displayed side by side; instead, only the service life curve 1802 of the component representing the earliest NG timing among multiple conditions after prediction of the failure timing, or only the NG timing of 5,000 prints at the prediction point X, may be displayed.

A method for predicting a failure timing under multiple conditions is not limited to the above method. A service life curve of the component may be calculated after a preserved print job is analyzed at prediction to acquire print conditions. For example, preserved print job information may be acquired via the external LAN 105 or the communication cable 260. Then, the failure timing may be predicted by comparing future and past magenta toner consumptions, which is a future printing condition and a past printing condition related to the cause of the precursor. Alternatively, humidity information may be acquired from an external input or an attached sensor, and the failure timing may be predicted based on the humidity conditions. The conditions for predicting the failure timing may vary depending on conditions or causes. A list of conditions to be considered may be previously stored in the HDD 216, and prediction may be performed after determining the condition to be considered according to the cause of the detected precursor. By taking into account conditions that affect the change rate of the service life of the component in failure prediction, prediction accuracy is improved, thereby enabling accurate notification to the user of the timing for automatic recovery or cleaning.

Thus, a precursor-image diagnosis process has been described, in which a precursor candidate is detected, a determination is made as to whether the precursor candidate is due to a time-dependent change in the service life of the component, and a notification is issued in accordance with the determination result. This obviates the need for non-precursor failure-timing prediction, thereby reducing the processing load and user burden.

### Second Embodiment

In the first embodiment, an example is described in which a time-dependent change in the service life of the component is determined according to the type of the component; however, a method for determining a time-dependent change in the service life of the component is not limited to above example. Here, a time-dependent change in the service life of the component is determined based on the progression of the service life of the component. Whether a time-dependent change in the service life of the component occurs is component-dependent. However, depending on the cause of the defect, the service life of the component may not exhibit any time-dependent change. In the above case, a defect without a time-dependent change in the service life of the component is erroneously determined to be a precursor, and its feature information continues to be stored and notifications indicating the presence of a precursor continue to be issued, thereby increasing the processing load and user burden.

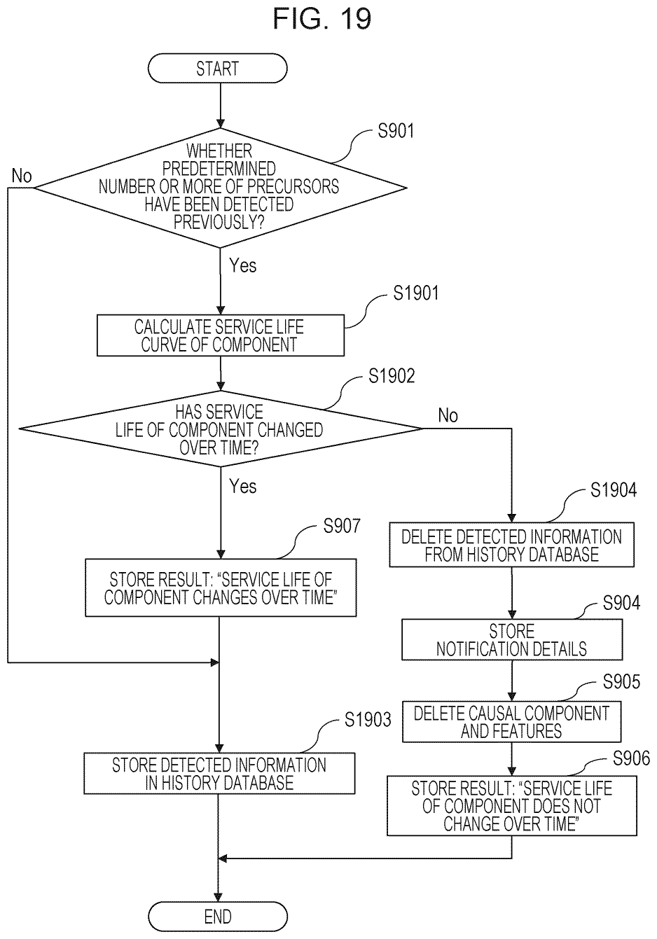

Accordingly, a method for determining whether a time-dependent change in the service life of the component occurs, based on the transition of past feature information relating to size and contrast will be described. FIG. 19 illustrates the detailed procedure of determining a time-dependent change in the service life of the component at step S806 according to the present embodiment. The configuration of the printing system and the procedure of the precursor diagnosis process according to the present embodiment are the same as those of the first embodiment, and a description thereof will be omitted. Steps S1901 to S1904 that differ from those in the first embodiment will be described.

At step S901, the CPU 214 determines whether a precursor candidate has been detected a predetermined number of times or more in the past. If a precursor candidate has not been detected a predetermined number of times or more (No in S901), the process proceeds to step S1903. If a precursor candidate has been detected a predetermined number of times or more (Yes in S901), the process proceeds to step S1901.

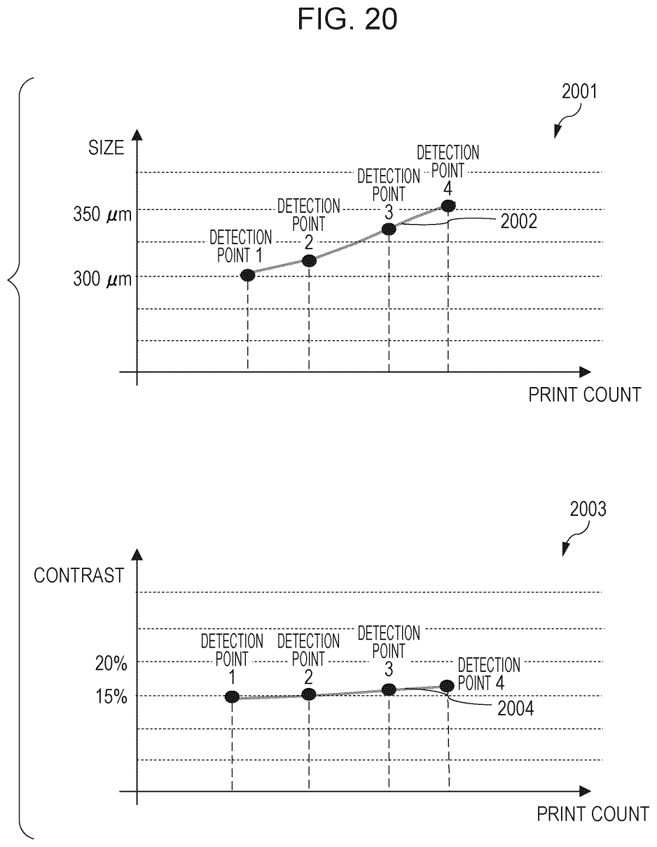

Next, at step S1901, the CPU 214 calculates the progression of the service life of the component. The CPU 214 reads the size and contrast values of previously detected precursor candidates from the HDD 216 and plots the values. The present embodiment describes a case in which a service life curve of the component is plotted. FIG. 20 illustrates examples of the service life curve of the component. Graph 2001 shows a case where a service life curve of the component is obtained with respect to the size. By plotting the detected precursors as detection points 1, 2, 3, and 4, a service life curve 2002 of the component is derived. Graph 2003 shows a case where a service life curve of the component is plotted, with the contrast as the axis. By plotting the detected precursors as detection points 1, 2, 3, and 4, a service life curve 2004 of the component is derived. The axis for calculating the service life curve of the component is not limited to size or contrast, but may be any axis by which a time-dependent change in the service life of the component can be determined, such as the number of occurrences per unit area, images, or rankings generated by machine learning. After calculating the service life curve of the component, the process proceeds to step S1902.

At step S1902, the CPU 214 determines whether the service life of the component has changed over time based on the service life curve of the component obtained at step S1901. The present embodiment describes an example in which the service life curve 2002 or 2004 of the component is evaluated to determine whether a time-dependent change in the service life of the component has occurred. Specifically, the CPU 214 obtains the minimum and maximum values of the curve, and when the difference therebetween is equal to or greater than a threshold, determines that the service life of the component has changed over time. Alternatively, the CPU 214 may obtain an approximate curve, and when the slope of a tangent thereof is equal to or greater than a threshold, may determine that the service life of the component has changed over time. The determination of the change may be made when either the size or the contrast has changed, or alternatively, only if both of the size and the contrast have changed. A threshold and an axis for determining a time-dependent change in the service life of the component may be set for each cause. If the service life of the component has changed over time (Yes in S1902), the process proceeds to step S907. If the service life of the component does not change over time (No in S1902), the process proceeds to step S1904.

Next, at step S907, the CPU 214 stores information indicating that the service life of the component changes over time in the HDD 216.

At step S1903, the CPU 214 stores the information on the detected precursors and precursor candidates in the history database of the HDD 216. The precursors and precursor candidates detected for each causal component and each occurrence location are stored for use in calculating the service life curve of each component.

Next, at step S1904, the CPU 214 deletes, from the history database, precursor candidates not due to a time-dependent change in the service life of the component. Continuing to store history data may consume memory resources. Accordingly, data older than a predetermined threshold may be deleted from the database. Alternatively, when the number of data items stored in the database exceeds an upper limit, older data may be deleted and replaced with new data. Since the subsequent steps S904 to S906 are the same as those in the first embodiment, a description thereof will be omitted.

Thus, a method for determining a time-dependent change in the service life of the component based on the transition of previously detected precursor candidates has been described. The determination based on the progression of the service life of the component enables detecting a defect not due to a time-dependent change in the service life of the component.

### Third Embodiment

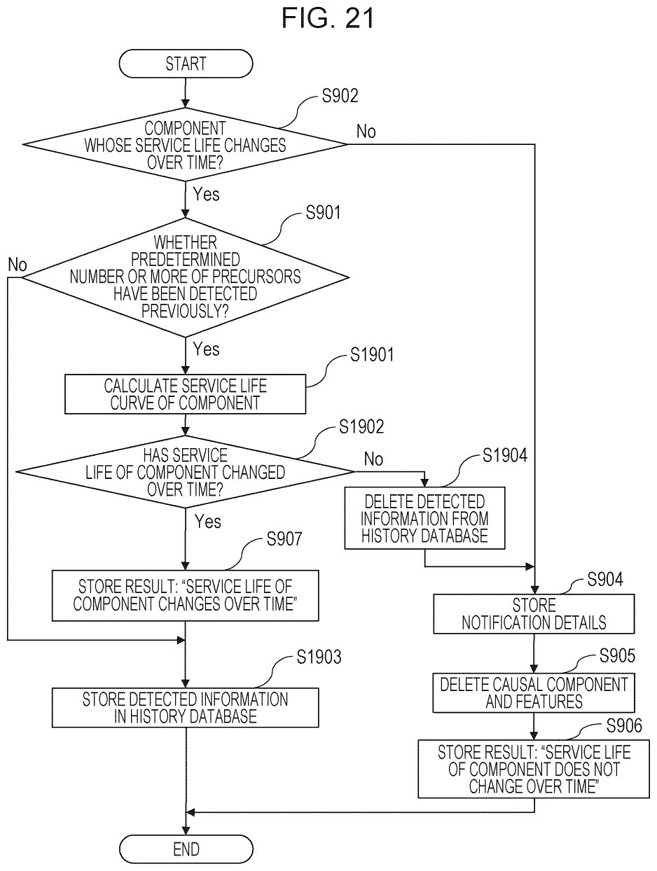

The present embodiment describes a case of determining a time-dependent change in the service life of the component based on the type of the component and the service life curve of the component. The advantageous effects of the present disclosure are not limited to those of the first and second embodiments. A time-dependent change in the service life of the component may be determined based on both the type of the component and the service life curve of the component. In the case of a component whose service life does not change over time, there is no need to calculate the service life curve of the component, and therefore, a time-dependent change in the service life of the component is determined based on the type of the component. In the case of a component whose service life may change over time, by obtaining the service life curve of the component and determining a time-dependent change in the service life of the component, processing load can be reduced and accuracy can be improved. FIG. 21 illustrates the detailed procedure of a precursor diagnosis process according to the third embodiment. The configuration of the printing system and the procedure of the precursor diagnosis process according to the present embodiment are the same as those of the first and second embodiments, and a description thereof will be omitted.

At step S902, the CPU 214 first determines whether the service life of the component changes based on the type of component. If the component is one whose service life changes over time (Yes in S902), the process proceeds to step S901. If the component is one whose service life does not change over time (No in S902), the process proceeds to step S904.

Next, at step S901, the CPU 214 determines whether a precursor was previously detected a plurality of times. If a precursor was detected a predetermined number of times or more (Yes in S901), the process proceeds to step S1901. If a precursor was not detected a predetermined number of times or more (No in S901), the process proceeds to step S1903.

Since the subsequent processes are the same as steps S904 to S907 of the first embodiment and steps S1902 to S1904 of the second embodiment, a description thereof will be omitted.

As described above, by determining a time-dependent change in the service life of the component based on the type of the component and the progression of the service life of the component, processing load is improved and determination accuracy is improved.

Having described various examples and embodiments of the present disclosure, it is to be understood that the spirit and scope of the present disclosure are not limited to the specific description set forth in this specification.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205844, filed Nov. 26, 2024, which is hereby incorporated by reference herein in its entirety.

What is claimed is:

1. An imaging diagnostic apparatus connected to a printer, the imaging diagnostic apparatus comprising:
a reading unit configured to read a printed product formed by the printer to generate a read image;
a notification unit configured to notify a user of information; and
a controller configured to detect whether an image defect exists in the read image, based on a reference image,
wherein, when the image defect is due to a time-dependent change in service life of a predetermined component, the controller causes the notification unit to issue a notification of a prediction result of a failure timing of the predetermined component.

2. The imaging diagnostic apparatus according to claim 1, wherein, when the image defect is not due to a time-dependent change in service life of a different component, the controller does not cause the notification unit to issue a notification of a prediction result of a failure timing of the different component.

3. The imaging diagnostic apparatus according to claim 2, wherein the different component includes at least one of a fixing roller, a line-scan, LS, unit, a developing sleeve, and a secondary transfer belt.

4. The imaging diagnostic apparatus according to claim 1, wherein the image defect is a defect that has occurred before the predetermined component reaches the service life.

5. The imaging diagnostic apparatus according to claim 1, wherein the controller determines whether the detected image defect is due to a time-dependent change in the service life of the predetermined component.

6. The imaging diagnostic apparatus according to claim 1, wherein, when the image defect is detected in the predetermined component, the controller causes the notification unit to change a notification indicating a countermeasure against the image defect and notification details of the prediction result of the failure timing, depending on a type of the image defect.

7. The imaging diagnostic apparatus according to claim 6, wherein the notification indicating a countermeasure against the image defect contains an instruction to automatically recover the predetermined component or an instruction to clean the predetermined component.

8. The imaging diagnostic apparatus according to claim 1, wherein the prediction result includes at least one of a remaining print count at which a failure of the predetermined component is predicted and a notification of cleaning of the printer in which a failure of the predetermined component is predicted.

9. The imaging diagnostic apparatus according to claim 1,
wherein the controller causes the notification unit to issue a notification of the prediction result in accordance with a predetermined setting, and
wherein the setting includes at least one of whether to provide a notification, a notification timing, a notification method, a repetition setting, and a notification of a variation in failure timing.

10. The imaging diagnostic apparatus according to claim 1, wherein the prediction result is calculated based on a predetermined value corresponding to a type of the predetermined component.

11. The imaging diagnostic apparatus according to claim 10, wherein the predetermined value includes size and contrast information.

12. The imaging diagnostic apparatus according to claim 1, wherein the predetermined component includes at least one of a photosensitive drum and a charging roller.

13. An imaging diagnostic system comprising:
a printing unit configured to print an image on a recording medium to generate a printed product;
a reading unit configured to read the printed product to generate a read image;
a notification unit configured to notify a user of information; and
a controller configured to detect whether an image defect exists in the read image, based on a reference image,
wherein, when the image defect is due to a time-dependent change in service life of a predetermined component, the controller causes the notification unit to issue a notification of a prediction result of a failure timing of the predetermined component.

14. The imaging diagnostic system according to claim 13, wherein, when the image defect is not due to a time-dependent change in service life of a different component, the controller does not cause the notification unit to issue a notification of a prediction result of a failure timing of the different component.

15. The imaging diagnostic system according to claim 13, wherein the image defect is a defect that has occurred before the predetermined component reaches the time-dependent service life thereof.

16. The imaging diagnostic system according to claim 13, wherein the controller determines whether the detected image defect is due to a time-dependent change in the service life of the predetermined component.

17. The imaging diagnostic system according to claim 13, wherein, when the image defect is detected in the predetermined component, the controller causes the notification unit to change a notification of information indicating a countermeasure against the image defect and notification details of the prediction result of the failure timing, depending on a type of the image defect.

18. The imaging diagnostic system according to claim 13,
wherein the controller causes the notification unit to issue a notification of the prediction result in accordance with a predetermined setting, and
wherein the setting includes at least one of whether to provide a notification, a notification timing, a notification method, a repetition setting, and a notification of a variation in failure timing.

19. The imaging diagnostic system according to claim 13, wherein the predetermined component includes at least one of a photosensitive drum and a charging roller.
